(19) United States
(12) Patent Application Publication
(10) Pub. No.: US 2004/0103399 A1
(43) Pub. Date: May 27, 2004

(54) Data trace compression map

(76) Inventors: Manisha Agarwala, Richardson, TX (US); Bryan Thome, Missouri City, TX (US); John M. Johnsen, Dallas, TX (US); Gary L. Swoboda, Sugarland, TX (US); Lewis Nardini, Dallas, TX (US); Maria B. H. Gill, Plano, TX (US)

Correspondence Address: TEXAS INSTRUMENTS INCORPORATED, P O BOX 655474, M/S 3999, DALLAS, TX, 75265

(21) Appl. No.: 10/301,935

(22) Filed: Nov. 22, 2002

(51) Int. Cl. G06F 9/44

(52) U.S. Cl. 717/128; 709/238

(57) ABSTRACT

Trace data compression includes selectively transmitting data packets, data addresses and program counter addresses and transmitting which are transmitted in a data log header. Trace data compression further includes determining and not transmitting most significant bytes of data, data address or program counter address having bits that all equal the most significant bit. This requires an indication of the data, data address and program counter address length. Trace data compression further includes transmitting only bytes of data, data address and program counter address which differ from corresponding byte of the prior data, data address and program counter address together with a map indicating which bytes are transmitted.

### TECHNICAL FIELD OF THE INVENTION

The technical field of this invention is emulation hardware particularly for highly integrated digital signal processing systems.

### BACKGROUND OF THE INVENTION

Advanced wafer lithography and surface-mount packaging technology are integrating increasingly complex functions at both the silicon and printed circuit board level of electronic design. Diminished physical access to circuits for test and emulation is an unfortunate consequence of denser designs and shrinking interconnect pitch. Designed-in testability is needed so the finished product is both controllable and observable during test and debug. Any manufacturing defect is preferably detectable during final test before a product is shipped. This basic necessity is difficult to achieve for complex designs without taking testability into account in the logic design phase so automatic test equipment can test the product.

In addition to testing for functionality and for manufacturing defects, application software development requires a similar level of simulation, observability and controllability in the system or sub-system design phase. The emulation phase of design should ensure that a system of one or more ICs (integrated circuits) functions correctly in the end equipment or application when linked with the system software. With the increasing use of ICs in the automotive industry, telecommunications, defense systems, and life support systems, thorough testing and extensive real-time debug becomes a critical need.

Functional testing, where the designer generates test vectors to ensure conformance to specification, still remains a widely used test methodology. For very large systems this method proves inadequate in providing a high level of detectable fault coverage. Automatically generated test patterns are desirable for full testability, and controllability and observability. These are key goals that span the full hierarchy of test from the system level to the transistor level.

Another problem in large designs is the long time and substantial expense involved in design for test. It would be desirable to have testability circuitry, system and methods that are consistent with a concept of design-for-reusability. In this way, subsequent devices and systems can have a low marginal design cost for testability, simulation and emulation by reusing the testability, simulation and emulation circuitry, systems and methods that are implemented in an initial device. Without a proactive testability, simulation and emulation plan, a large amount of subsequent design time would be expended on test pattern creation and upgrading.

Even if a significant investment were made to design a module to be reusable and to fully create and grade its test patterns, subsequent use of a module may bury it in application specific logic. This would make its access difficult or impossible. Consequently, it is desirable to avoid this pitfall.

The advances of IC design are accompanied by decreased internal visibility and control, reduced fault coverage and reduced ability to toggle states, more test development and verification problems, increased complexity of design simulation and continually increasing cost of CAD (computer aided design) tools. In the board design the side effects include decreased register visibility and control, complicated debug and simulation in design verification, loss of conventional emulation due to loss of physical access by packaging many circuits in one package, increased routing complexity on the board, increased costs of design tools, mixed-mode packaging, and design for produceability. In application development, some side effects are decreased visibility of states, high speed emulation difficulties, scaled time simulation, increased debugging complexity, and increased costs of emulators. Production side effects involve decreased visibility and control, complications in test vectors and models, increased test complexity, mixed-mode packaging, continually increasing costs of automatic test equipment and tighter tolerances.

Emulation technology utilizing scan based emulation and multiprocessing debug was introduced more than 10 years ago. In 1988, the change from conventional in circuit emulation to scan based emulation was motivated by design cycle time pressures and newly available space for on-chip emulation. Design cycle time pressure was created by three factors. Higher integration levels, such as increased use of on-chip memory, demand more design time. Increasing clock rates mean that emulation support logic causes increased electrical intrusiveness. More sophisticated packaging causes emulator connectivity issues. Today these same factors, with new twists, are challenging the ability of a scan based emulator to deliver the system debug facilities needed by today's complex, higher clock rate, highly integrated designs. The resulting systems are smaller, faster, and cheaper. They have higher performance and footprints that are increasingly dense. Each of these positive system trends adversely affects the observation of system activity, the key enabler for rapid system development. The effect is called “vanishing visibility.”

FIG. 1 illustrates the trend in visibility and control over time and greater system integration. Application developers prefer the optimum visibility level illustrated in FIG. 1. This optimum visibility level provides visibility and control of all relevant system activity. The steady progression of integration levels and increases in clock rates steadily decrease the actual visibility and control available over time. These forces create a visibility and control gap, the difference between the optimum visibility and control level and the actual level available. Over time, this gap will widen. Application development tool vendors are striving to minimize the gap growth rate. Development tools software and associated hardware components must do more with less resources and in different ways. Tackling this ease of use challenge is amplified by these forces.

With today's highly integrated System-On-a-Chip (SOC) technology, the visibility and control gap has widened dramatically over time. Traditional debug options such as logic analyzers and partitioned prototype systems are unable to keep pace with the integration levels and ever increasing clock rates of today's systems. As integration levels increase, system buses connecting numerous subsystem components move on chip, denying traditional logic analyzers access to these buses. With limited or no significant bus visibility, tools like logic analyzers cannot be used to view system activity or provide the trigger mechanisms needed to control the system under development. A loss of control accompanies this loss in visibility, as it is difficult to control things that are not accessible.

To combat this trend, system designers have worked to keep these buses exposed. Thus the system components were built in a way that enabled the construction of prototyping systems with exposed buses. This approach is also under siege from the ever-increasing March of system clock rates. As the central processing unit (CPU) clock rates increase, chip to chip interface speeds are not keeping pace. Developers find that a partitioned system's performance does not keep pace with its integrated counterpart, due to interface wait states added to compensate for lagging chip to chip communication rates. At some point, this performance degradation reaches intolerable levels and the partitioned prototype system is no longer a viable debug option. In the current era production devices must serve as the platform for application development.

Increasing CPU clock rates are also limiting availability of other simple visibility mechanisms. Since the CPU clock rates can exceed the maximum I/O state rates, visibility ports exporting information in native form can no longer keep up with the CPU. On-chip subsystems are also operated at clock rates that are slower than the CPU clock rate. This approach may be used to simplify system design and reduce power consumption. These developments mean simple visibility ports can no longer be counted on to deliver a clear view of CPU activity. As visibility and control diminish, the development tools used to develop the application become less productive. The tools also appear harder to use due to the increasing tool complexity required to maintain visibility and control. The visibility, control, and ease of use issues created by systems-on-a-chip tend to lengthen product development cycles.

Even as the integration trends present developers with a tough debug environment, they also present hope that new approaches to debug problems will emerge. The increased densities and clock rates that create development cycle time pressures also create opportunities to solve them. On-chip, debug facilities are more affordable than ever before. As high speed, high performance chips are increasingly dominated by very large memory structures, the system cost associated with the random logic accompanying the CPU and memory subsystems is dropping as a percentage of total system cost. The incremental cost of several thousand gates is at an all time low. Circuits of this size may in some cases be tucked into a corner of today's chip designs. The incremental cost per pin in today's high density packages has also dropped. This makes it easy to allocate more pins for debug. The combination of affordable gates and pins enables the deployment of new, on-chip emulation facilities needed to address the challenges created by systems-on-a-chip.

When production devices also serve as the application debug platform, they must provide sufficient debug capabilities to support time to market objectives. Since the debugging requirements vary with different applications, it is highly desirable to be able to adjust the on-chip debug facilities to balance time to market and cost needs. Since these on-chip capabilities affect the chip's recurring cost, the scalability of any solution is of primary importance. “Pay only for what you need” should be the guiding principle for on-chip tools deployment. In this new paradigm, the system architect may also specify the on-chip debug facilities along with the remainder of functionality, balancing chip cost constraints and the debug needs of the product development team.

FIG. 2 illustrates an emulator system 100 including four emulator components. These four components are: a debugger application program 110; a host computer 120; an emulation controller 130; and on-chip debug facilities 140. FIG. 2 illustrates the connections of these components. Host computer 120 is connected to an emulation controller 130 external to host 120. Emulation controller 130 is also connected to target system 140. The user preferably controls the target application on target system 140 through debugger application program 110.

Host computer 120 is generally a personal computer. Host computer 120 provides access the debug capabilities through emulator controller 130. Debugger application program 110 presents the debug capabilities in a user-friendly form via host computer 120. The debug resources are allocated by debug application program 110 on an as needed basis, relieving the user of this burden. Source level debug utilizes the debug resources, hiding their complexity from the user. Debugger application program 110 together with the on-chip trace and triggering facilities provide a means to select, record, and display chip activity of interest. Trace displays are automatically correlated to the source code that generated the trace log. The emulator provides both the debug control and trace recording function.

The debug facilities are preferably programmed using standard emulator debug accesses through a JTAG or similar serial debug interface. Since pins are at a premium, the preferred embodiment of the invention provides for the sharing of the debug pin pool by trace, trigger, and other debug functions with a small increment in silicon cost. Fixed pin formats may also be supported. When the pin sharing option is deployed, the debug pin utilization is determined at the beginning of each debug session before target system 140 is directed to run the application program. This maximizes the trace export bandwidth. Trace bandwidth is maximized by allocating the maximum number of pins to trace.

The debug capability and building blocks within a system may vary. Debugger application program 100 therefore establishes the configuration at runtime. This approach requires the hardware blocks to meet a set of constraints dealing with configuration and register organization. Other components provide a hardware search capability designed to locate the blocks and other peripherals in the system memory map. Debugger application program 110 uses a search facility to locate the resources. The address where the modules are located and a type ID uniquely identifies each block found. Once the IDs are found, a design database may be used to ascertain the exact configuration and all system inputs and outputs.

Host computer 120 generally includes at least 64 Mbytes of memory and is capable of running Windows 95, SR-2, Windows NT, or later versions of Windows. Host computer 120 must support one of the communications interfaces required by the emulator. These may include: Ethernet 10T and 100T, TCP/IP protocol; Universal Serial Bus (USB); Firewire IEEE 1394; and parallel port such as SPP, EPP and ECP.

Host computer 120 plays a major role in determining the real-time data exchange bandwidth. First, the host to emulator communication plays a major role in defining the maximum sustained real-time data exchange bandwidth because emulator controller 130 must empty its receive real-time data exchange buffers as fast as they are filled. Secondly, host computer 120 originating or receiving the real-time data exchange data must have sufficient processing capacity or disc bandwidth to sustain the preparation and transmission or processing and storing of the received real-time data exchange data. A state of the art personal computer with a Firewire communication channel (IEEE 1394) is preferred to obtain the highest real-time data exchange bandwidth. This bandwidth can be as much as ten times greater performance than other communication options.

Emulation controller 130 provides a bridge between host computer 120 and target system 140. Emulation controller 130 handles all debug information passed between debugger application program 110 running on host computer 120 and a target application executing on target system 140. A presently preferred minimum emulator configuration supports all of the following capabilities: real-time emulation; real-time data exchange; trace; and advanced analysis.

Emulation controller 130 preferably accesses real-time emulation capabilities such as execution control, memory, and register access via a 3, 4, or 5 bit scan based interface. Real-time data exchange capabilities can be accessed by scan or by using three higher bandwidth real-time data exchange formats that use direct target to emulator connections other than scan. The input and output triggers allow other system components to signal the chip with debug events and vice-versa. Bit I/O allows the emulator to stimulate or monitor system inputs and outputs. Bit I/O can be used to support factory test and other low bandwidth, non-time-critical emulator/target operations. Extended operating modes are used to specify device test and emulation operating modes. Emulator controller 130 is partitioned into communication and emulation sections. The communication section supports host communication links while the emulation section interfaces to the target, managing target debug functions and the device debug port. Emulation controller 130 communicates with host computer 120 using one of industry standard communication links outlined earlier herein. The host to emulator connection is established with off the shelf cabling technology. Host to emulator separation is governed by the standards applied to the interface used.

Emulation controller 130 communicates with the target system 140 through a target cable or cables. Debug, trace, triggers, and real-time data exchange capabilities share the target cable, and in some cases, the same device pins. More than one target cable may be required when the target system 140 deploys a trace width that cannot be accommodated in a single cable. All trace, real-time data exchange, and debug communication occurs over this link. Emulator controller 130 preferably allows for a target to emulator separation of at least two feet. This emulation technology is capable of test clock rates up to 50 MHZ and trace clock rates from 200 to 300 MHZ, or higher. Even though the emulator design uses techniques that should relax target system 140 constraints, signaling between emulator controller 130 and target system 140 at these rates requires design diligence. This emulation technology may impose restrictions on the placement of chip debug pins, board layout, and requires precise pin timings. On-chip pin macros are provided to assist in meeting timing constraints.

The on-chip debug facilities offer the developer a rich set of development capability in a two tiered, scalable approach. The first tier delivers functionality utilizing the real-time emulation capability built into a CPU's mega-modules. This real-time emulation capability has fixed functionality and is permanently part of the CPU while the high performance real-time data exchange, advanced analysis, and trace functions are added outside of the core in most cases. The capabilities are individually selected for addition to a chip. The addition of emulation peripherals to the system design creates the second tier functionality. A cost-effective library of emulation peripherals contains the building blocks to create systems and permits the construction of advanced analysis, high performance real-time data exchange, and trace capabilities. In the preferred embodiment five standard debug configurations are offered, although custom configurations are also supported. The specific configurations are covered later herein.

### SUMMARY OF THE INVENTION

In the case of tracing processor activity and generating data streams typically timing and program counter activity has a limited impact on the bandwidth. However as soon as data log activity is generated for tracing target processor activity the volume of data explodes.

In the case of tracing processor activity and generating data streams there are many things that can be traced. This greatly increases the volume of data that needs to be exported. Therefore a scheme is needed to enable sending out the data information in a compressed form to enable maximum bandwidth usage.

### BRIEF DESCRIPTION OF THE DRAWINGS

These and other aspects of this invention are illustrated in the drawings, in which:

FIG. 1 illustrates the visibility and control of typical integrated circuits as a function of time due to increasing system integration;

FIG. 2 illustrates an emulation system to which this invention is applicable;

FIG. 3 illustrates in block diagram form a typical integrated circuit employing configurable emulation capability;

FIG. 4 illustrates schematically a trace data transmission protocol according to the prior art;

FIG. 5 illustrates schematically a trace data transmission protocol according to a first aspect of this invention;

FIG. 6 illustrates schematically a trace data transmission protocol according to a second aspect of this invention; and

FIG. 7 illustrates schematically a trace data transmission protocol according to a third aspect of this invention.

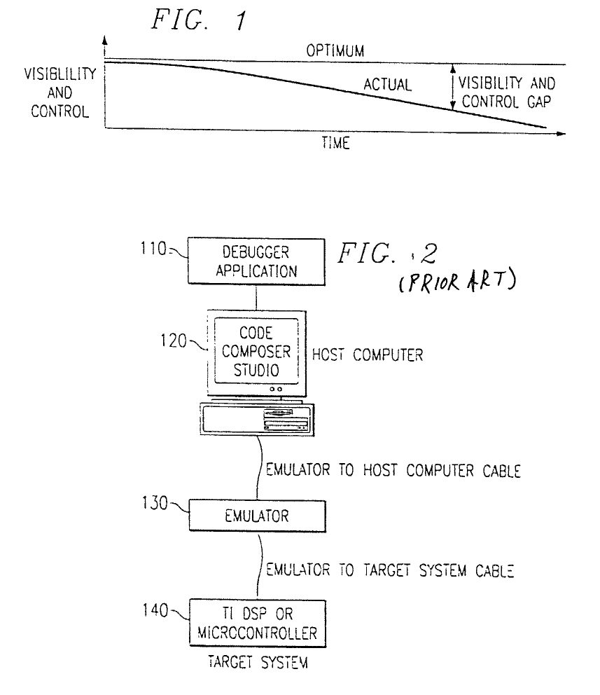

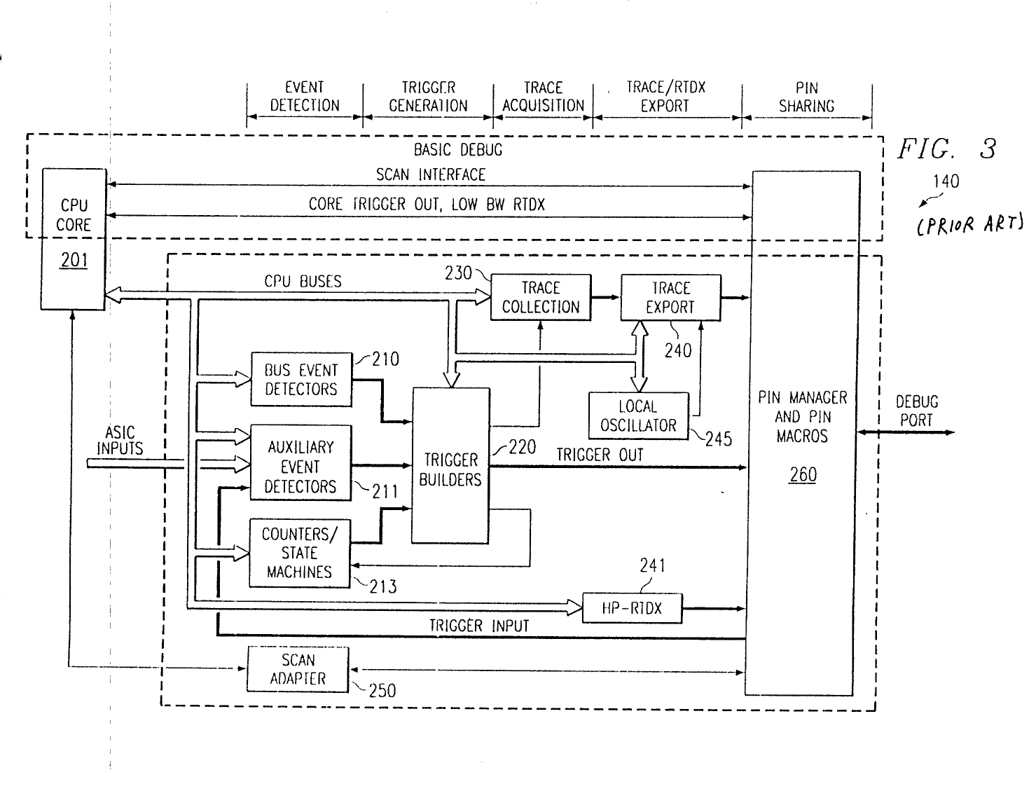

### DETAILED DESCRIPTION OF PREFERRED EMBODIMENTS

Various streams are synchronized using markers called sync points. The sync points provide a unique identifier field and a context to the data that will follow it. All streams may generate a sync point with this unique identifier. The information in the sync point is valid only at a legal instruction boundary.

FIG. 3 illustrates an example of one on-chip debug architecture embodying target system 140. The architecture uses several module classes to create the debug function. One of these classes is event detectors including bus event detectors 210, auxiliary event detectors 211 and counters/state machines 213. A second class of modules is trigger generators including trigger builders 220. A third class of modules is data acquisition including trace collection 230 and formatting. A fourth class of modules is data export including trace export 240, and real-time data exchange export 241. Trace export 240 is controlled by clock signals from local oscillator 245. Local oscillator 245 will be described in detail below. A final class of modules is scan adaptor 250, which interfaces scan input/output to CPU core 201. Final data formatting and pin selection occurs in pin manager and pin micros 260.

The size of the debug function and its associated capabilities for any particular embodiment of a system-on-chip may be adjusted by either deleting complete functions or limiting the number of event detectors and trigger builders deployed. Additionally, the trace function can be incrementally increased from program counter trace only to program counter and data trace along with ASIC and CPU generated data. The real-time data exchange function may also be optionally deployed. The ability to customize on-chip tools changes the application development paradigm. Historically, all chip designs with a given CPU core were limited to a fixed set of debug capability. Now, an optimized debug capability is available for each chip design. This paradigm change gives system architects the tools needed to manage product development risk at an affordable cost. Note that the same CPU core may be used with differing peripherals with differing pin outs to embody differing system-on-chip products. These differing embodiments may require differing debug and emulation resources. The modularity of this invention permits each such embodiment to include only the necessary debug and emulation resources for the particular system-on-chip application.

The real-time emulation debug infrastructure component is used to tackle basic debug and instrumentation operations related to application development. It contains all execution control and register visibility capabilities and a minimal set of real-time data exchange and analysis such as breakpoint and watch-point capabilities. These debug operations use on-chip hardware facilities to control the execution of the application and gain access to registers and memory. Some of the debug operations which may be supported by real-time emulation are: setting a software breakpoint and observing the machine state at that point; single step code advance to observe exact instruction by instruction decision making; detecting a spurious write to a known memory location; and viewing and changing memory and peripheral registers.

Real-time emulation facilities are incorporated into a CPU mega-module and are woven into the fabric of CPU core 201. This assures designs using CPU core 201 have sufficient debug facilities to support debugger application program 110 baseline debug, instrumentation, and data transfer capabilities. Each CPU core 201 incorporates a baseline set of emulation capabilities. These capabilities include but are not limited to: execution control such as run, single instruction step, halt and free run; displaying and modifying registers and memory; breakpoints including software and minimal hardware program breakpoints; and watch-points including minimal hardware data breakpoints.

For the case of tracing processor activity, data streams are generated which log various aspects of the memory logs. Examples of some aspects that can be traced are: data log; address of the data log; program counter at which the data log occurred. Therefore at the minimum a data log must have a unique encoding which marks the start of data log. This can then be continued with bit combinations that indicate the start of the data and continue packets that will give the data values. This is then followed by a unique combination indicating the start of the data address followed by the address itself. It is terminated by yet another unique combination indicating the start of the program counter address followed by the address itself.

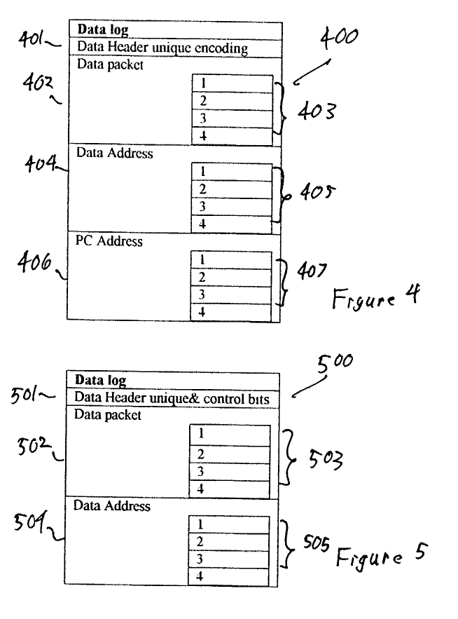

FIG. 4 illustrates an example of a data log 400. Data log 400 includes data header unique coding 401, data packet section 402 including data entries 403, data address section 404 including data addresses 405 and program counter address section 406 including program counter addresses 407.

Table 1 shows an example series of packets:

TABLE 1

| Data | | | Unique | Significance |
|---|---|---|---|---|
| encoding | Comment | Value | Encoding | of encoding |
| 0011xxxxxx | | | 0011 | Start of a new |
| | | | | data log |
| 10 00000000 | Data byte 0 | 0 × 00 | 10 | Start of data |
| | | | | bytes |
| 10 00010001 | Data byte 1 | 0 × 11 | 10 | Data bytes |
| | | | | continue |
| 10 00100010 | Data byte 2 | 0 × 22 | 10 | Data bytes |
| | | | | continue |
| 10 00110011 | Data byte 3 | 0 × 33 | 10 | Data bytes |
| | | | | continue |
| 10 01000100 | Data byte 4 | 0 × 44 | 10 | Data bytes |
| | | | | continue |
| 10 01010101 | Data byte 5 | 0 × 55 | 10 | Data bytes |
| | | | | continue |
| 10 01100110 | Data byte 6 | 0 × 66 | 10 | Data bytes |
| | | | | continue |
| 10 01110111 | Data byte 7 | 0 × 77 | 10 | Data bytes |
| | | | | continue |
| 01 00000000 | Data address | 0 × 00 | 01 | Start of data |
| | byte 0 | | | address bytes |
| 10 00010001 | Data address | 0 × 11 | 10 | Data address |
| | byte 1 | | | bytes continue |
| 10 00100010 | Data address | 0 × 22 | 10 | Data address |
| | byte 2 | | | bytes continue |
| 10 00110011 | Data address | 0 × 33 | 10 | Data address |
| | byte 3 | | | bytes continue |
| 01 00000000 | PC address | 0 × 00 | 01 | Start of PC |
| | byte 0 | | | address bytes |
| 10 00010001 | PC address | 0 × 11 | 10 | PC address |
| | byte 1 | | | bytes continue |
| 10 00100010 | PC address | 0 × 22 | 10 | PC address |
| | byte 2 | | | bytes continue |
| 10 00110011 | PC address | 0 × 33 | 10 | PC address |
| | byte 3 | | | bytes continue |

As shown in Table 1 for a double word (64 bits) data size, 17 packets of 10 bits each need to be transmitted. Note that the initial 10 bit packet includes the initial bits “0011” which indicate the start of a new data log.

It is possible that the user is not interested in tracing all the fields of the data log is only tracing certain aspects of the stream. For example, the user may not be interested in program counter address trace. However the above scheme has no flexibility available to the user to limit data transmission to only desired data. To achieve this flexibility, some control information needs to be sent along with the data log. This permits the user to know that the trace does not have program counter address information for example.

FIG. 5 illustrates an example data log 500 for this case. Data log 500 includes data header unique encoding and control bits 501. The data header unique encoding marks the beginning of the data packet of format 500. The control bits indicate the data, data address, program counter address for the data log are being traced respectively or not. Data log 500 also includes data packet section 502 including data entries 403 and data address section 504 including data addresses 505. An example series of packets is shown in Table 2.

TABLE 2

| Data | | | Unique | Significance |
|---|---|---|---|---|
| encoding | Comment | Value | Encoding | of encoding |
| 0011xxxCCC | CCC are | | 0011 | New data log, |
| | control bits | | | no PC address |
| 10 00000000 | Data byte 0 | 0 × 00 | 10 | Start of data |
| | | | | bytes |
| 10 00010001 | Data byte 1 | 0 × 11 | 10 | Data bytes |
| | | | | continue |
| 10 00100010 | Data byte 2 | 0 × 22 | 10 | Data bytes |
| | | | | continue |
| 10 00110011 | Data byte 3 | 0 × 33 | 10 | Data bytes |
| | | | | continue |
| 10 01000100 | Data byte 4 | 0 × 44 | 10 | Data bytes |
| | | | | continue |
| 10 01010101 | Data byte 5 | 0 × 55 | 10 | Data bytes |
| | | | | continue |
| 10 01100110 | Data byte 6 | 0 × 66 | 10 | Data bytes |
| | | | | continue |
| 10 01110111 | Data byte 7 | 0 × 77 | 10 | Data bytes |
| | | | | continue |
| 01 00000000 | Data address | 0 × 00 | 01 | Start of data |
| | byte 0 | | | address bytes |
| 10 00010001 | Data address | 0 × 11 | 10 | Data address |
| | byte 1 | | | bytes continue |
| 10 00100010 | Data address | 0 × 22 | 10 | Data address |
| | byte 2 | | | bytes continue |
| 10 00110011 | Data address | 0 × 33 | 10 | Data address |
| | byte 3 | | | bytes continue |

The initial 10 bit packet in this example includes three least significant bits which code that no program counter addresses are included in this data log. Alternative initial 10 bit packets could indicate which of data, data address and program counter address are included in that series.

Additional bandwidth can be saved using sign extension on each of the three fields of the data log. Since data-address and program counter address have a fixed length, sign extension is trivial in those cases. It is a more complicated for data packets, since the data can be of varying lengths (1byte, 2-byte, 4-bytes). In this case, the control information can be integrated into the control bits.

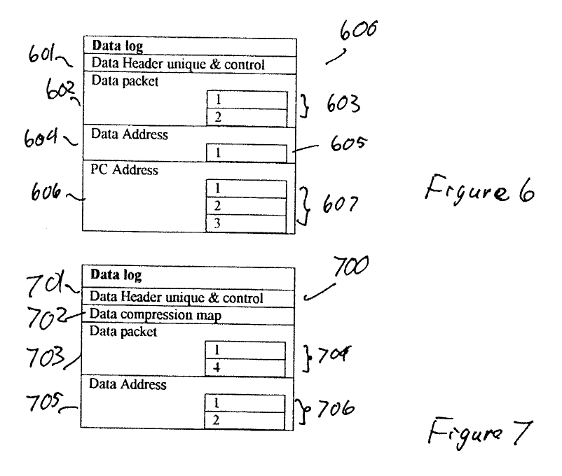

FIG. 6 illustrates an example data log 600 in this case. Data header unique encoding and control bits 601 indicates the start of a new data log, that data, data address program counter address are being sent and a data size of the data. The data address and the program counter address are assumed to be 32 bits. The data section 602 data entries 503, data address section 604 includes data address 605 and program counter address section 606 includes program counter addresses 607. Table 3 shows an example of a series of packets coded in this fashion.

TABLE 3

| Data | | | Unique | Significance |
|---|---|---|---|---|
| encoding | Comment | Value | Encoding | of encoding |
| 0011CCCCC | CCCCC are | | 0011 | New data log, |
| | control bits | | | data size is |
| | | | | 64 bits |
| 10 00000000 | Data byte 0 | 0 × 00 | 10 | Start of data |
| | | | | bytes |
| 10 11111111 | Data byte 1 | 0 × FF | 10 | Data bytes |
| | | | | continue |
| 01 00110011 | Data address | 0 × 33 | 01 | Start of data |
| | byte 0 | | | address bytes |
| 01 00000000 | PC address | 0 × 00 | 01 | Start of PC |
| | byte 0 | | | address bytes |
| 10 00010001 | PC address | 0 × 11 | 10 | PC address |
| | byte 1 | | | bytes continue |
| 10 00100010 | PC address | 0 × 22 | 10 | PC address |
| | byte 2 | | | bytes continue |

Applying sign extension compression to the example of Table 3, the data originally sent out 0xFF00 extends to a 64 bit value 0xFFFFFFFFFFFFFF00. The data address sent out as 0x33 extends to 0x00000033. The PC address sent out as 0x221100 extends to 0x00221100. Therefore the data transmitted in data log 600 is reduced without losing information. In the example of FIG. 6 and Table 3, only two bytes of data, only one byte of data address and only three bytes of program counter address need to be transmitted.

An alternate data compression technique compares current data to the previous data and sends out only those bytes that are different. In this case another packet needs to be sent out which can indicate the bytes that are being sent. This additional byte is referred to as compression map. FIG. 7 illustrates an example of such a data log. In data log 700, data header unique encoding and control bits 701 indicate which of data, data address and program counter address which is being sent out. Compression map 702 indicates which bytes are being sent. Data packet section 703 includes data entries 704 and data address section 705 includes data addresses 706.

An example of this data compression is shown below in Tables 4, 5 and 6. Table 4 shows an example where no data compression is possible.

TABLE 4

| Previous data | 11111111 | 11101111 | 11111101 | 10000001 |
|---|---|---|---|---|
| New data | 11110111 | 11111111 | 11111111 | 10000011 |
| XOR new and previous | 00001000 | 00010000 | 00000010 | 00000010 |
| data | | | | |
| Match (0) | 1 | 1 | 1 | 1 |
| Miscompare (1) | | | | |
| Compression Byte Map | 1 | 1 | 1 | 1 |
| Compression Byte Map | No, no bytes XOR match | | | |
| sent? | | | | |
| Send bytes | Sent | Sent | Sent | Sent |

Bytes 3-0 are sent

In the example of Table 4 none of the prior and new data bytes match. Therefore no data compression is available using this byte matching technique. Table 5 shows an example where compression is obtainable using byte matching.

TABLE 5

| | | | | |
|---|---|---|---|---|
| Previous data | 11111111 | 11111111 | 11111111 | 00000000 |
| New data | 11101111 | 11111111 | 11111111 | 00000000 |
| XOR new and previous | 00010000 | 00000000 | 00000000 | 00000000 |
| data | | | | |
| Match (0) | 1 | 0 | 0 | 0 |
| Miscompare (1) | | | | |
| Compression Byte Map | 1 | 0 | 0 | 0 |
| Send bytes | sent | dropped | dropped | dropped |

Byte #3 is sent

Table 6 shows an example packet stream employing this byte match compression technique.

TABLE 6

| Data | | | Unique | Significance |
|---|---|---|---|---|
| encoding | Comment | Value | Encoding | of encoding |
| 0011CCCCC | CCCCC are | | 0011 | New data log, |
| | control bits | | | data size is |
| | | | | 32 bits |
| 01 00001000 | Compression | 0 × 08 | 01 | Indicates the |
| | map | | | bytes sent |
| 10 11101111 | Data byte 3 | 0 × EF | 10 | Data bytes |
| | | | | continue |
| 01 00110011 | Data address | 0 × 33 | 01 | Start of data |
| | byte 0 | | | address bytes |
| 01 00000000 | PC address | 0 × 00 | 01 | Start of PC |
| | byte 0 | | | address bytes |
| 10 00010001 | PC address | 0 × 11 | 10 | PC address |
| | byte 1 | | | bytes continue |
| 10 00100010 | PC address | 0 × 22 | 10 | PC address |
| | byte 2 | | | bytes continue |

In Table 6 the control bits indicate that there is data, data address and program counter address which being sent out. Furthermore the data itself is 32 bits wide. The compression map indicates that only one data byte, byte 3, is being sent. Therefore the user knows that the other three data bytes are identical to the previous data log. The data address and program counter address is assumed to be 32 bits.

Therefore if we take compression map, the previous data was 0xFFFFFF00. The new data has a compression map of 0x08 and data byte 3 is 0xEF. Therefore the new data is 0xEFFFFF00. Applying sign extension to the data address and program counter address, the data address sent out as 0x33 extends to 0x00000033. The PC address sent out as 0x221100 extends to 0x00221100.

Sign extension can be further applied to this example for data. Therefore if the data can also be sign extended, then even though the compression map indicates that the data is being sent, it will not be sent. Using any of these techniques alone or in conjunction with any other technique can significantly save the bandwidth.

What is claimed is:

1. A method of trace data compression comprising the steps of:
selecting transmission of at least one of data packets, data addresses and program counter addresses;
transmitting a data log header identifying which of said data packets, data addresses and program counter addresses are selected; and
transmitting said selected at least one of data packets, data addresses and program counter addresses.

2. The method of trace data compression of claim 1, wherein:
said step of transmitting includes sequentially transmitting a predetermined amount of data if
transmission of data packets was selected, transmitting a predetermined amount of data
addresses if transmission of data addresses was selected, and
transmitting a predetermined amount of program counter addresses if transmission of program counter addresses was selected.

3. A method of trace data compression comprising the steps of:
determining if all bits in equal sized sections of a predetermined length of most significant bits of data equal a most significant bit of said data;
determining if all bits in said sections of said predetermined length of a data address equal a most significant bit of said data address;
determining if all bits in said sections of said predetermined length of a program counter address equal a most significant bit of said program counter address;
indicating a length of said data, said data address and said program counter;
transmitting least significant sections of data up to a last section of data determined to not to have all bits equal to said most significant bit of said data;
transmitting least significant sections of data address up to a last section of data address determined to not to have all bits equal to said most significant bit of said data address;
transmitting least significant sections of program counter address up to a last section of program counter address determined to not to have all bits equal to said most significant bit of program counter address.

4. The method of trace data compression of claim 3, wherein:
said equally sized sections each consist of 8 bits.

5. The method of trace data compression of claim 3, wherein:
said step of indicating a length of said data, said data address and said program counter includes
transmitting a header including a data length indication, and
assuming said data address and said program counter address have a predetermined length.

6. A method of trace data compression comprising the steps of:
comparing equal sized sections of current data with immediately prior data and generating an indication of which sections differ;
comparing equal sized sections of a current data address with immediately prior data address and generating an indication of which sections differ;
comparing equal sized sections of current program counter address with immediately prior program counter address and generating an indication of which sections differ;
transmitting a map of sections of said current data that differs from said immediately prior data;
transmitting sections of said current data that differ from said immediately prior data;
transmitting a map of sections of said current data address that differs from said immediately prior data address;
transmitting sections of said current data address that differ from said immediately prior data address;
transmitting a map of sections of said current program counter address that differs from said immediately prior program counter address; and
transmitting sections of said current program counter address that differ from said immediately prior program counter address.

7. The method of trace data compression of claim 6, wherein:
said equally sized sections each consist of 8 bits.
